(19) United States
(12) Patent Application Publication
(10) Pub. No.: US 2006/0097618 A1
(43) Pub. Date: May 11, 2006

(54) Colour cathode ray tubes

(75) Inventors: Renzo Incagli, Colleferro-Roma (IT); Tommaso Petitti, It-Anagni (IL); Silvio Santovincenzo, Anagni (IT); Stefano Necci, Anagni (IT); Paolo Ginesti, Gavignano (IT); Massimiliano Manzato, Anagni (IT)

Correspondence Address: THOMSON LICENSING INC., PATENT OPERATIONS, PO BOX 5312, PRINCETON, NJ, 08543-5312, US

(73) Assignee: Thomson Licensing, Inc., Princeton, NJ (US)

(21) Appl. No.: 10/524,125

(22) PCT Filed: Aug. 7, 2003
(86) PCT No.: PCT/FR03/02482

§ 371 Date: Sep. 26, 2005

(30) Foreign Application Priority Data
Aug. 13, 2002 (FR) 02A001824

(51) Int. Cl. H01J 29/80

(52) U.S. Cl. 313/402

(57) ABSTRACT

The invention concerns cathode ray tubes with substantially planar front surface, whereof the colour selecting mask is produced by swaging. The mask comprises an active surface enclosed by a solid peripheral edge terminated by a skirt substantially perpendicular to the active surface. In order to rigidify the active surface in a direction parallel to the main axis, the mean radius of curvature of said active surface is greater than the mean radius of curvature of the peripheral edge.

The present invention relates to a colour cathode-ray tube having a substantially flat screen, and more specifically, to the colour selection mask equipping such a tube.

The invention is applicable to any type of tube having a colour selection mask and is more particularly suitable for tubes whose mask is produced by stamping held by a rigid frame to which it is secured.

A conventional colour cathode-ray tube consists of an evacuated glass envelope. Inside the envelope, the tube has a colour selection mask located at a specific distance from the glass front face of the tube, a front face on which red, green and blue phosphor arrays are deposited in order to form a screen. An electron gun placed inside the tube, in its rear part, generates three electron beams in the direction of the front face. An electromagnetic deflection device, generally placed outside the tube and close to the electron gun, has the function of deflecting the electron beams in order to make them scan the surface of the panel on which the phosphor arrays are placed. Under the influence of three electron beams, each one corresponding to a particular primary colour, the phosphor arrays make it possible to reproduce coloured images on the screen, the mask enabling each particular beam to illuminate only the phosphor of the corresponding colour.

The colour selection mask must be placed and held during tube operation in a precise position inside the tube. The functions of holding the mask are carried out by means of a generally very rigid rectangular metal frame to which the mask is conventionally welded.

The frame/mask assembly is mounted in the front face of the tube by virtue of suspension means welded to the frame and cooperating with pins inserted in the glass forming the front face of the tube.

The colour selection mask is made from a very thin metal sheet and has a surface, called an active surface, perforated with openings, produced by chemical etching and generally arranged in vertical columns; the active surface is surrounded by an unperforated peripheral border; a skirt, generally produced by stamping, borders the assembly while lying in a direction substantially perpendicular to the active surface. The mask is secured to the frame by welding at the skirt.

The current trend is for tubes whose front face is increasingly flat, with a tendency towards completely flat front faces. For the spectator, the visibility of an image formed on the screen of the tube is influenced by the shape of the glass front face of the tube, and in particular, by the inner and outer surfaces of the said front face. In the case of a tube having a front face whose outer surface is substantially flat, the inner surface may be curved, in particular to provide mechanical strength for the glass envelope, curves leading to additional thicknesses of glass which are visible for the spectator. New generations of tube have made it possible to overcome this problem by having inner and outer surfaces defined by a very large radius of curvature.

In general, the surface of the mask must follow the shape of the inner part of the front face of the tube, such that their curvature is substantially identical. The colour selection mask of a conventional tube has a surface defined by horizontal and vertical sections, the radii of curvature of which are small, of the order of one or two metres in the central region; this curved surface may be represented by a complex polynomial expression and the small value of the radii of curvature provides the mechanical rigidity of the mask surface.

In the case of a tube where the screen appears flat, the radii of curvature defining the surface of the mask have large values. In this case, the surface of the mask facing the screen of the tube is substantially flat and no longer provides sufficient mechanical rigidity to keep this entire surface at a predetermined distance from the said screen. Moreover, the mask becomes very sensitive to external vibrations; under the influence of external impact or mechanical vibrations, for example acoustic vibrations due to the loudspeakers of the television set in which the tube is inserted, the mask may then vibrate at its natural resonant frequency. The consequence of the mask vibrations is to modify the landing zone of the electron beams on the screen of the tube, the points of impact of each beam then being offset with respect to the associated phosphor array, thus creating discolouration of the image reproduced on the screen.

The subject of the present invention is a colour cathode-ray tube, the mask of which, for example formed by stamping, has sufficient mechanical rigidity to avoid the drawbacks associated with a substantially flat surface.

For this, the colour cathode-ray tube according to the invention comprises:

a substantially flat rectangular front face,

a rectangular-shaped colour selection mask defined by two axes of symmetry, the horizontal major axis and the vertical minor axis intersecting at the centre of an active surface perforated with orifices, the said active surface being surrounded by a peripheral border and by a skirt lying in a direction substantially perpendicular to the active surface,

a rectangular frame secured to the skirt of the mask by welding

characterized in that in a direction parallel to the major axis, the mean radius of curvature Rₛₑ of the active surface of the mask is greater than the mean radius of curvature R_{bp} of the peripheral border.

The invention and its various advantages will be better understood with the help of the description below and the drawings, among which:

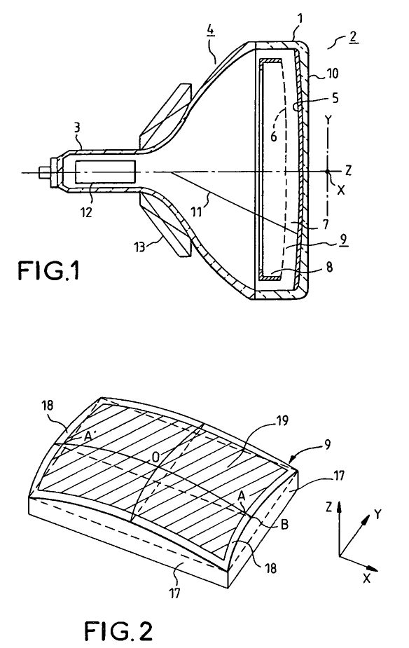

FIG. 1 shows in section a cathode-ray tube according to the invention with its various operational components;

FIG. 2 shows, in isometric projection, a colour selection mask for a cathode-ray tube according to the prior art;

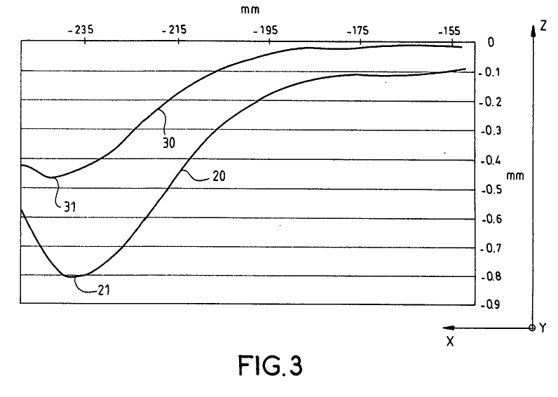

FIG. 3 illustrates, by a sectional view, the problems encountered by a mask whose surface is defined by a large radius of curvature along the major axis X;

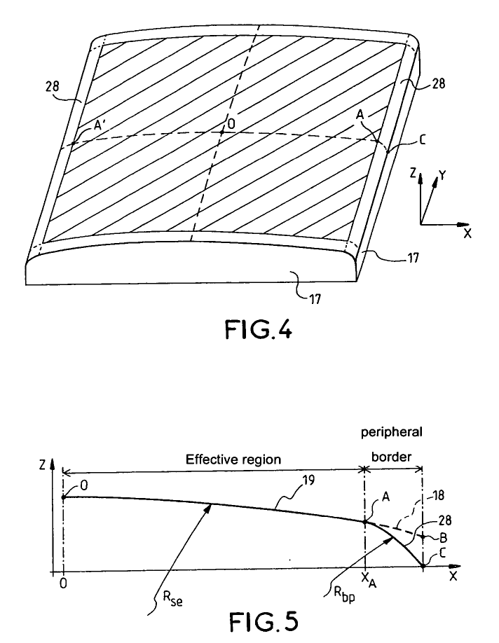

FIG. 4 shows in perspective a colour selection mask-according to the invention;

FIG. 5 is a section along the major axis of a mask according to the invention.

FIG. 1 describes a colour cathode-ray tube according to the invention. The tube comprises a glass envelope in which there is a high vacuum, the envelope consisting of a front face 2 and a funnel-shaped rear part 4. A lateral skirt 1 surrounds the front face 2 which has a substantially flat and rectangular outer face 10. The major axis of the front face is a horizontal axis X, the minor axis is a vertical axis Y and the two axes X and Y intersect the main axis Z of the tube at right angles. The funnel-shaped rear part 4 terminates in a cylindrical part 3 inside which there is an electron gun 12. A luminescent screen 5, consisting of an array of strips of green, red and blue luminescent materials, is deposited on the inner surface of the front face.

A colour selection mask 9 is placed inside the glass envelope and is secured on its periphery to a rigid frame 8 intended to keep it in place with respect to the screen 5.

FIG. 2 illustrates one embodiment of a mask according to the prior art in which the mask has an active surface 19 perforated with a multitude of openings placed at regular intervals, the active surface being surrounded by a full peripheral border 18; while the mask is being formed, generally by stamping a flat metal sheet, a skirt 17 is made, lying in the direction of the main axis Z, substantially perpendicular to the border 18.

The electron gun 12 emits three electron beams 11 in the direction of the screen 5. The three beams are deflected by a magnetic deflection device 13, also called a deflector. The coloured images are displayed on the screen 5 when the electron beams 11 passing through the openings 6 of the mask are scanned horizontally and vertically over the said screen.

The tube according to the invention has an outer surface 10 of the substantially flat front face. To prevent distortions of images formed on the screen of the tube which are annoying for the spectator, such as differences in luminosity on the various parts of the screen, or differences due to variable thickness of the front face, the current trend is to make the inner surface of the said front face as flat as possible so as to minimize the variations in thickness of the glass. The tube designer is then confronted with a choice of using a mask with a high radius of curvature, or of using a mask whose curvature follows the curvature of the inner surface of the front face.

The first solution has the advantage of providing considerable mechanical rigidity and also the advantage that during the step of forming the mask, usually carried out by stamping, the mechanical stresses generated by the shape of the mask guarantee that it keeps this shape. However, the variations in distance between the active surface of the mask and the screen for various regions of this active surface cause deterioration in the quality of the image formed on the screen, in particular on the peripheral regions, the impacts of the electron beams on the screen then being broadened and deformed, with respect to the centre.

The second solution makes it possible to minimize the variations in distance between the active surface of the mask and the screen; however, the mask will then have a substantially flat surface with few mechanical stresses caused by this shape. The result of this is that once secured to the frame, the mask has weak regions, as illustrated in FIG. 3.

In this figure, the profile 20 of a mask according to the prior art is shown in section, for a 4/3 format tube with a screen diagonal of 68 cm; the section is taken along the major axis X, FIG. 3 showing more particularly the region located near to the vertical border, at a distance of between 155 mm and 250 mm from the centre O of the mask; the surface of the mask has, along the major axis X, a mean radius of curvature Rₛₑ greater than 3000 mm between the extreme points A and A′ of the said active surface. It can be seen that close to the vertical edge the mask tends to sag in the direction of the Z axis providing a hollow 21 with a depth of a few tenths of a millimetre. This hollow has a width of more than 30 mm in the horizontal direction X and lies in the vertical direction Y over virtually the entire height of the active surface of the mask. This region, apart from the fact that it will be likely to expand more easily than other parts of the mask, introduces problems of sensitivity of the mask to vibrations due to the tube's surroundings.

This problem, encountered on the 4/3 format tubes, is even more marked on 16/9 format tubes for which this ratio between the width and the length of the mask is unfavourable to the mechanical holding of the surface of the mask.

Similarly, since the folds around the skirt of the mask are regions of rigidification, masks with a large surface area, for example for a tube with a diagonal greater than 63 cm, have large portions away from these folded regions and are more likely to be confronted with this problem.

The invention aims to keep the advantages of holding the active region of the mask substantially parallel to an inner surface of the front face defined by large radii of curvature, which means that this substantially flat active surface can be kept without having to suffer the drawbacks of mechanical behaviour of the said surface.

For this, the invention uses the full peripheral border parallel to the minor axis Y. Although, as indicated in FIGS. 2 and 5, this region 18 was, in the prior art, continuous with the active surface 19 and the skirt 17, the said novel peripheral border 28 has, in the direction parallel to the major axis, a much larger radius of curvature than the radius of curvature of the active surface.

Thus, in the case of the mask of a W66 tube, whose active surface 19 had, along the major axis, between the end points A and A′ of the said active surface, a mean radius of curvature Rₛₑ of 3250 mm, the mean radius of curvature R_{bp} of the peripheral border at the major axis, between the end points A and B of the said border, was of the same order of magnitude. In the case of the invention, as illustrated by FIGS. 4 and 5, the mean radius of curvature R_{bp} of the peripheral border 28 is chosen equal to 62 mm at the major axis, between the end points A and C of the said border.

Experience has shown that, in order to obtain a decisive advantage concerning the mechanical holding of the mask surface, it is necessary for the radius of curvature of the peripheral border 28, at the major axis, to be at least ten times smaller than the radius of curvature of the active surface of the mask.

For large tubes, that is to say with a screen diagonal greater than 63 cm, it is preferable that the peripheral border have an even higher radius of curvature. Depending on the size of the mask and its format (4/3 or 16/9), the ratio between R_{bp}/Rₛₑ may, within the scope of the invention, then advantageously be chosen between 0.01 and 0.05.

In one embodiment (not shown), the radius of curvature of the peripheral border 28 varies from the point A representing the middle of the vertical side up to the corner of the mask so that this radius decreases on moving away from the point A. This characteristic facilitates forming the mask at its corners without penalizing the advantages supplied by the invention since, on approaching the corners of the mask, the folded regions are approached, which provide enough mechanical stress to ensure the surface of the mask is held in these regions.

FIG. 3 illustrates the improvements provided by the invention. The profile of the active surface of the mask with a 68 cm diagonal, in the region where there was a pronounced hollow 21, has been modified such that the new profile 30 obtained by implementing the invention now only has a hollow 31 of less than a tenth of a millimetre, complying with the admissible tolerances in the manufacture and operation of cathode-ray tubes.

In order to simplify manufacture of the mask, the passage, in a direction parallel to the major axis X, from the active region of the mask to the peripheral border 28 is continuous such that the slopes of the tangents to the surface of the mask on the side of the active surface and peripheral border are equal. This makes it easier to control the final shape of the mask since an angular tradition introduces significant mechanical stresses which it is difficult to overcome completely by the stamping method.

Thus, since the surface of the mask is defined by a polynomial expression of the type:
Z=ΣAᵢX^{K(i)}Y^{J(i)} in the active region
Z′=ΣA′ᵢX^{K′(i)}Y^{J′(i)} in the peripheral region
this results in
   Z(X_{A},Y)=Z′(X_{A},Y)
   and
   δ_{X}Z(X_{A},Y)=δ_{X}Z′(X_{A},Y)

where A is a point of the boundary between the active region of the mask and the peripheral border 28.

The invention is not limited to tubes having a flat front face. For any type of tube, the invention in fact has the advantage of strengthening the mechanical integrity of the mask such that local expansions of the mask are minimized in the case of an image having very different regions of light intensity. Specifically, in this case, the active surface of the mask in the brightest regions is heated and tends to expand, which locally decreases the distance between the mask and the screen; this local expansion leads to colour variations which are detrimental to the good rendition of the image.

1. Colour cathode ray tube, comprising:
a rectangular front face,
a rectangular-shaped colour selection mask defined by two axes of symmetry, the horizontal major axis X and the vertical minor axis Y intersecting at the centre of an active surface perforated with orifices, the said active surface being surrounded by a peripheral border and by a skirt lying in a direction Z substantially perpendicular to the active surface,
a rectangular frame secured to the skirt of the mask by welding, wherein in a direction parallel to the major axis, the mean radius of curvature Rₛₑ of the active surface of the mask is greater than the mean radius of curvature R_{bp} of the peripheral border.

2. Colour cathode-ray tube according to claim 1, wherein the outer surface of the front face is substantially flat.

3. Colour cathode-ray tube according to claim 2, wherein along the major axis, the mean radius of curvature Rₛₑ of the active surface of the mask is at least 10 times greater than the mean radius of curvature R_{bp} of the peripheral border.

4. Colour cathode-ray tube according to claim 2, wherein the front face of the tube has a diagonal greater than 63 cm and in that along the major axis, the ratio between the mean radius of curvature Rₛₑ of the active surface of the mask and the mean radius of curvature R_{bp} of the peripheral border is such that:
0.01<R_{bp}/Rₛₑ<0.05.

5. Cathode-ray tube according to claim 1, wherein the radius of curvature changes continuously at the boundary between the active surface and the peripheral border.

6. Colour cathode-ray tube according to claim 5, wherein, in a direction parallel to the major axis, at the boundary between the active surface of the mask and the peripheral border, the slopes of the tangents to the surface of the mask on the side of the active surface and peripheral border are equal.

7. Cathode-ray tube according to claim 1, wherein the mean radius of curvature of the peripheral border in a direction parallel to the major axis is smaller at the corners of the frame than at the major axis.

8. Cathode-ray tube according to claim 2, wherein the mean radius of curvature Rₛₑ along the major axis is greater than 3000 mm.
